(19) United States
(12) Patent Application Publication
(10) Pub. No.: US 2025/0078797 A1
(43) Pub. Date: Mar. 6, 2025

(54) Method for Generating an Imperceptible Stimulus Signal for On-line Secondary Path for Automotive Active Noise Control Systems

(71) Applicant: Harman International Industries, Incorporated, Stamford, CT (US)

(72) Inventors: Kevin J. Bastyr, Franklin, MI (US); Sattwik Basu, Urbana, IL (US); Jeffrey Charles Tackett, Allen Park, MI (US); David Trumpy, Novi, MI (US)

(73) Assignee: Harman International Industries, Incorporated, Stamford, CT (US)

(21) Appl. No.: 18/462,223

(22) Filed: Sep. 6, 2023

(51) Int. Cl. G10K 11/175; G10K 11/178

(52) U.S. Cl. CPC G10K 11/1752; G10K 11/17825; G10K 11/17853; G10K 11/17883

(57) ABSTRACT

A system and method for generating a stimulus signal as a solution for an adaptive secondary path component of an active noise cancellation (ANC) system having at least one audio signal source to provide an audio signal in a cabin of the vehicle, a shaped noise generator provides a shaped-noise signal in the cabin of the vehicle, at least one controller programmed to activate the shaped noise generator and add the shaped noise signal to the audio signal to generate a stimulus signal, and at least one loudspeaker to project the stimulus signal within the cabin of the vehicle for the ANC system to generate an anti-noise signal.

### CROSS REFERENCE TO RELATED APPLICATIONS

The entire disclosures of U.S. Non-Provisional application Ser. No. 17/975,782, filed Oct. 28, 2022, entitled “SYSTEM AND METHOD FOR ESTIMATING SECONDARY PATH IMPULSE RESPONSE FOR ACTIVE NOISE CANCELLATION” and U.S. Non-Provisional application Ser. No. 17/976,048, filed on Oct. 28, 2022, entitled “SYSTEM AND METHOD FOR SECONDARY PATH SWITCHING FOR ACTIVE NOISE CANCELLATION” are hereby incorporated by reference into the present disclosure.

### TECHNICAL FIELD

Aspects disclosed herein generally relate to a system and method for generating an imperceptible stimulus signal for on-line adaptive secondary path switching for Active Noise Control (ANC) systems. These aspects and others will be discussed in more detail herein.

### BACKGROUND OF THE INVENTION

Active noise cancellation (ANC) systems attenuate undesired noise using feedforward and feedback structures to adaptively remove undesired noise within a listening environment, such as within a vehicle cabin. ANC systems cancel, or reduce, unwanted noise by generating cancellation sound waves to destructively interfere with the unwanted audible noise. ANC systems implemented on a vehicle that minimize noise inside the vehicle cabin include a Road Noise Cancellation (RNC) system, which minimizes unwanted road noise, and an Engine Order Cancellation (EOC) system, which minimizes undesirable engine noise inside the vehicle cabin.

Typically, ANC systems use digital signal processing and digital filtering techniques. For example, a noise sensor, such as a microphone, an accelerometer, or a revolutions per minute (RPM) sensor, outputs an electrical reference signal representing a disturbing noise signal generated by a noise source. This reference signal is fed to an adaptive filter. The filtered references signal is then supplied to an acoustic actuator, for example a loudspeaker, which generates a compensating sound field, which may ideally have an opposite phase and close to identical magnitude to the noise signal. This compensating sound field eliminates, or reduces, the noise signal within the vehicle cabin.

The RNC system is a specific ANC system implemented on a vehicle to minimize undesirable road noise inside the vehicle cabin. RNC systems use vibration sensors to sense road induced vibration generated from the tire and road interface that leads to unwanted audible road noise. Cancelling such road noise results in a more pleasurable ride for vehicle passengers, and it enables vehicle manufacturers to use lightweight materials, thereby decreasing energy consumption and reducing emissions. The EOC system is a specific ANC system implemented on a vehicle to minimize undesirable engine noise inside the vehicle cabin. EOC systems use a non-acoustic sensor, such as an engine speed sensor, to generate a signal representative of the engine crankshaft rotational speed in revolutions-per-minute (RPM) as a reference. RNC systems are typically designed to cancel broadband signals, while EOC systems are designed and optimized to cancel narrowband signals, such as individual engine orders. ANC systems within a vehicle may provide both RNC and EOC technologies.

A residual noise signal may be measured, using a microphone for example, to provide an error signal to the adaptive filter's adaptation unit, where filter coefficients (also called parameters) of the adaptive filter are modified such that a norm of the error signal is produced. The adaptive filter's adaptation unit may use digital signal processing methods, such as least means square (LMS), filtered-x least mean square (FxLMS), modified filtered-x least mean square (MFxLMS), or other techniques, to reduce the error signal.

An estimated model that represents an acoustic transmission path from the loudspeaker to the microphone is used when applying many variants of the LMS algorithm, such as the FxLMS and MFxLMS algorithms. This acoustic transmission path is typically referred to as the secondary path of the ANC system. In contrast, the acoustic transmission path from the noise source to the microphone is typically referred to as the primary path of the ANC system. The secondary path transfer function represented in the time domain is often termed the impulse response, or IR.

The way the estimated secondary path transfer function matches the actual secondary path transfer function influences the stability of the ANC system. A varying secondary path transfer function can have a negative impact on the ANC system because the actual secondary path transfer function, when subjected to variations, no longer matches an “a priori” estimated secondary path transfer function that is used in the FxLMS or MFxLMS algorithm. The estimated model of the secondary path is typically measured once during the production tuning process and approximates the secondary path transfer function and during the production tuning process, the secondary path transfer function is estimated for a “nominal” acoustic scenario (i.e., one occupant, windows closed, seats in default positions). However, the secondary path can vary for many different reasons, like changes in occupancy count, seat positions, items in the listening environment. These differences between the stored, estimated secondary path and the actual secondary path may lead to inadequate noise cancellation system performance, or even to diverging adaptive filters, which causes undesirable noise being generated in the listening environment, often termed noise boosting.

A solution is known in which the ANC system selects the closest impulse response, from a set of reference impulse responses, based on an online (real time) measurement using decorrelated audio signals. This component of the ANC is called an Adaptive Secondary Path (ASP) system. ASP uses audio signals from audio with content that spans a frequency range of interest for typical noise cancellation algorithms, for example, 20 Hz to 1000 Hz. In addition, the audio signals must be received at the microphone with sufficient sound pressure level to allow the adaptive filters to converge. ASP requires simultaneous decorrelated signals from each loudspeaker, and typically, will use audio, such as music, as a source for the decorrelated signals so that the decorrelated signals have sufficient levels while remaining imperceptible to occupants.

There are many instances when the ASP system is active, but the audio level is below levels that are necessary for audio signals to be received at a microphone with sufficient sound pressure level that will allow adaptive filters to converge. And when this is the case, ASP will not function properly. Examples of an audio level below what is necessary may occur, for example, when occupants have audio turned off, are listening to low volume audio, listening to talk radio, communicating with a voice assistant, participating in voice dialog in other forms of media, and participating in a phone conversation.

Therefore, there is a need for a method for generating multi-channel sound for ASP. The stimulus signal has low perceivability to an occupant in the vehicle.

### SUMMARY OF THE INVENTION

The inventive subject matter is a system and method for generating multi-channel sound used by an ASP when learning secondary paths. The multi-channel sound used by the ASP is a plurality of stimulus signals wherein a stimulus signal is generated for each speaker, for example, in a vehicle audio system. The stimulus signal has low perceivability for occupants when audio levels are insufficient for learning secondary paths. This is accomplished by generating shaped noise to play a unique signal over a vehicle's audio system. The shaped noise is added to an alternate audio source signal to generate each unique stimulus signal for the ASP system having sufficient content to allow the adaptive filters in ASP to converge.

The inventive subject matter comprises a feedback system for adjusting a volume of a noise based on vehicle operation and a method for generating shaped noise to be used in ASP systems.

A system and method for generating a stimulus signal for an adaptive secondary path of an active noise cancellation (ANC) system in a vehicle is described hereinafter. The system and method have at least one audio signal source to provide an audio signal in a cabin of the vehicle; a shaped noise generator to provide a shaped noise signal in the cabin of the vehicle; at least one controller programmed to activate the shaped noise generator and add the shaped noise signal to the audio signal to generate a stimulus signal; and at least one loudspeaker to project the stimulus signal within the cabin of the vehicle for the ANC system to generate an anti-noise signal.

In one or more embodiments, the microphone provides a signal indicative of a noise level in the cabin and a gain scheduling component adjusts a gain of the shaped noise signal to psychoacoustically mask the shaped noise signal and to maintain a constant signal to noise ratio (SNR). The gain adjusted shaped noise signal is added to the audio signal thereby generating a stimulus signal.

In one or more embodiments the shaped noise generator is a pre-recorded signal.

In one or more embodiments, the pre-recorded signal is a looping masked signal.

In one or more embodiments, the pre-recorded signal is a chime of the vehicle.

In one or more embodiments, the shaped noise generator has an active sound design (ASD) system.

In one or more embodiments, a linear predictive coding component applies a set of predetermined LPC synthesis filters to generate a stimulus signal.

In one or more embodiments, the linear predictive coding component uses an input from an error microphone and updates LPC synthesis filters in real time.

### BRIEF DESCRIPTION OF DRAWINGS

FIG. 1 is a block diagram of an active noise control (ANC) system with adaptive secondary path (ASP) system;

FIG. 2 is a block diagram of one or more embodiments of a shaped noise generator;

FIG. 3 is a block diagram of one or more embodiments of a shaped noise generator;

FIG. 4 is a block diagram of one or more embodiments of a shaped noise generator;

FIG. 5 is a block diagram of LPC analysis according to the shaped noise generator shown in FIG. 4;

FIG. 6 is a block diagram of one or more embodiments of a shaped noise generator; and

FIG. 7 is a flowchart for a method for performing secondary path switching using IR fingerprinting in accordance with one embodiment.

### DETAILED DESCRIPTION OF THE INVENTION

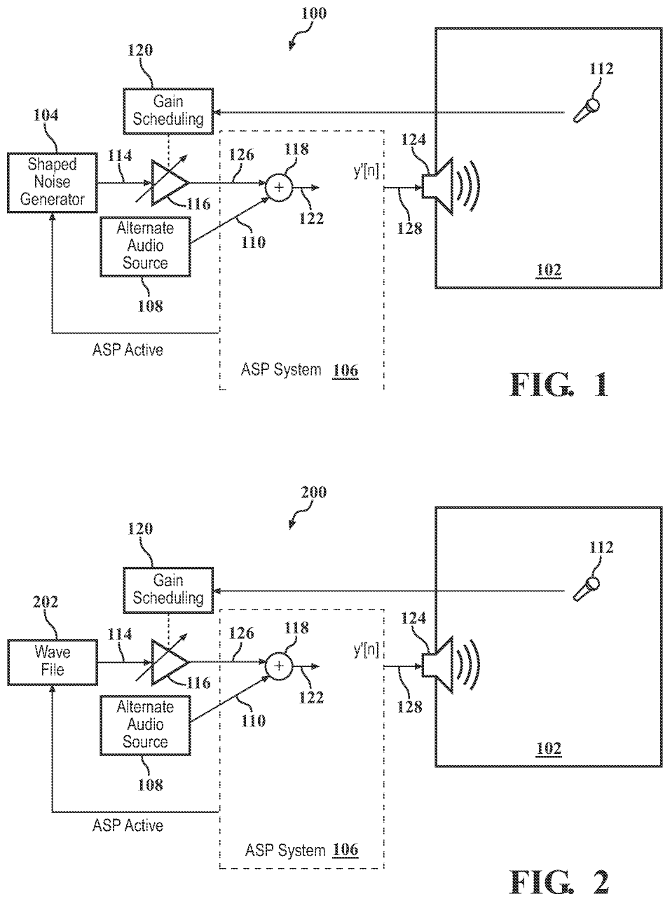

FIG. 1 generally depicts an overall block diagram 100 for active noise control (ANC) with adaptive secondary path (ASP) in a vehicle cabin 102. The system 100 includes at least one controller and memory. According to the inventive subject matter, a shaped noise generator 104 generates a shaped noise signal 104 that is supplied to an Adaptive Secondary Path (ASP) system 106. The ASP 106 and operation thereof is not described herein but is described in detail in U.S. Non-Provisional application Ser. No. 17/975,782, filed Oct. 28, 2022, entitled “SYSTEM AND METHOD FOR ESTIMATING SECONDARY PATH IMPULSE RESPONSE FOR ACTIVE NOISE CANCELLATION” and U.S. Non-Provisional application Ser. No. 17/976,048, filed on Oct. 28, 2022, entitled “SYSTEM AND METHOD FOR SECONDARY PATH SWITCHING FOR ACTIVE NOISE CANCELLATION” which are incorporated by reference into the present disclosure. The inventive subject matter provides a solution for using ASP when there is a lack of audio with content sufficient for adaptive filters in the ASP system to converge.

It is recognized that the systems comprise, and the methods are carried out by, controllers as disclosed herein. The controllers may include various microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform step(s) disclosed herein. In addition, such controllers as disclosed utilize one or more microprocessors to execute a computer-program that is embodied in a non-transitory computer readable medium that is programmed to perform any number of the functions as disclosed. Further, the controller(s) as provided herein includes a housing and the various number of microprocessors, integrated circuits, and memory devices ((e.g., FLASH, random access memory (RAM), read only memory (ROM), electrically programmable read only memory (EPROM), electrically erasable programmable read only memory (EEPROM)) positioned within the housing. The controller(s) as disclosed also include hardware-based inputs and outputs for receiving and transmitting data, respectively from and to other hardware-based devices as discussed herein.

An alternate audio source 108 provides an audio signal 110 that may include typical entertainment or voice audio. The audio signal 110 should include content that spans a frequency range of interest for typical noise cancellation algorithms and has a sufficient sound pressure level to allow the adaptive filters of the ASP system 106 to converge. A noise level in the vehicle cabin 102 is monitored by a microphone 112 in the vehicle cabin 102, and the ANC system 100 will determine when the ASP system 106 needs to run and the ANC system 100 will enable or disable the shaped noise generator 104 as needed. The microphone 112 measures an error signal that is used by the ANC system, a gain scheduling component 120, and a shaped noise generator 104. It should be noted that while one microphone 112 is shown, typically there are multiple microphones 112 throughout the vehicle cabin 102. For example, at each seat location within the vehicle cabin 102, but for simplicity purposes, only one microphone is shown. Similarly, the methods that are described hereinafter generate a unique shaped noise signal 114 for each seat location within the vehicle cabin. However, for simplicity purposes a single step, or single element, is described.

For situations when the ASP is active, but the audio signal 110 is deficient of audio with content that meets the requirements for the ASP, the ANC system 100 enables the shaped noise generator 104 so that the shaped noise generator 104 provides a shaped noise signal 114, that is gain adjusted 116 and then added 118 to the audio signal 110.

Based on the noise level detected by the microphone 112 in the vehicle cabin 102, the ASP system 106 will instruct a gain scheduling component 120 to adjust 116 a gain of the shaped noise signal 114 output by the shaped noise generator 104 to generate a gain adjusted shaped noise signal 126. The gain adjusted shaped noise signal 126, when combined with the audio signal 110, generates a stimulus signal 122 that is sufficient for the ASP system 106 to operate effectively. The stimulus signal 122 is processed, as described in detail in U.S. Non-Provisional application Ser. No. 17/975,782, filed Oct. 28, 2022, entitled “SYSTEM AND METHOD FOR ESTIMATING SECONDARY PATH IMPULSE RESPONSE FOR ACTIVE NOISE CANCELLATION”, to ensure the signals are decorrelated prior to being added to a corresponding ANC anti-noise signal 128 that is output to one or more loudspeakers 124 in the vehicle cabin 102.

The shaped noise generator 104 may be implemented in one of several embodiments to be described in detail later herein. The gain scheduling component 120 increases or decreases the volume of the shaped noise signal 114 with the goal of maintaining a constant signal to noise ratio (SNR). For example, in a scenario where a constant 10 dB SNR is desired and the vehicle cabin 102 has a 40 dBA sound pressure level (SPL), the output of the shaped noise generator 104 may be gained up to 50 dBA SPL.

The gain scheduling component 120 also seeks to achieve one or more psycho acoustic masking requirements to ensure that the stimulus signal 122 is imperceptible to vehicle occupants. For example, if a primary engine order noise is at 50 Hz, the gain of the output of the shaped noise generator 104 may be increased within a critical bandwidth masked by a 50 Hz tone. Calculating gain may be completed in any one or more known methods. By way of example, for a single input single output (SISO) system, the gain may be calculated as follows:

$$G [ n ] = \sqrt{\frac{{P}_{e} [ n ]}{( R [ n ] + 1 ) {P}_{\hat{s}} [ n ]}} where$$

$${P}_{e} [ n ] = λ {P}_{e} [ n - 1 ] + ( 1 - λ ) {e}^{2} [ n ] ,$$

$${P}_{\hat{s}} [ n ] = λ {P}_{\hat{s}} [ n - 1 ] + ( 1 - λ ) {\hat{s}}^{T} [ n ] s [ n ]$$

Expanding to a multiple input multiple output (MIMO) system, means, for microphone, m, the gain may be calculated as follows:

$$\begin{matrix}{G}_{m} [ n ] = \sqrt{\frac{{P}_{e m} [ n ]}{( R [ n ] + 1 ) {\sum }_{l = 1}^{n L} {P}_{s l m} [ n ]}} \\ {G}_{final} [ n ] = max ( {G}_{m} [ n ] )\end{matrix}$$

with exponential smoothing is applied to the final gain.

For any one of the methods for generating shaped noise that will be described later herein, the gain adjusted shaped noise signal 126 and audio signal 110 are combined to generate the stimulus signal 122. The stimulus signal 122 is played over the vehicle's audio system with sufficient content to allow the adaptive filters in ASP 106 to converge. The stimulus signal 122 is constructed, or masked, so that when it is played over the vehicle's audio system during normal vehicle operation, it is imperceptible to the vehicle's occupants.

One feature of the stimulus signal 122 that makes it nearly imperceptible is a limited bandwidth. Human hearing is less sensitive at lower frequencies. Therefore, the bandwidth of the stimulus signal 122 is limited to frequencies below those capable of being heard by a human ear.

In one or more embodiments, the stimulus signal is nearly imperceptible because the gain scheduling component 120 adjusts 116 the gain of the shaped noise signal 114 based on the noise level in the vehicle cabin 102. In one or more embodiments, the stimulus signal 122, through spectral shaping, may be kept to frequencies near a tonal noise, to be masked by the tonal noise and therefor, imperceptible to vehicle occupants. In one or more embodiments, masking sounds before and after the stimulus signal, through temporal gain scheduling, keeps the stimulus signal imperceptible to the human ear.

Referring to FIG. 2, one or more embodiments of the shaped noise generator 104 is shown in a block diagram 200. The shaped noise signal 114 may be a pre-recorded signal 202, that is either in a compressed or uncompressed format depending on available memory. For example, but not limited to, a wave file (.WAV or .WAVE) which is a digital audio file encoded in a standard audio format. The pre-recorded signal 202 may be stored in memory and, when the ASP system 106 is active and the audio signal 110 from the alternate audio source 108 is deemed insufficient by the ANC, the ASP activates the shaped noise generator to output the pre-recorded signal 202 as the shaped noise signal 114. The shaped noise signal 114 is modified, if necessary, by the gain scheduling component 120 to generate the gain shaped noise signal 126 that is added 118 to the audio signal 110 to generate the stimulus signal 122.

The pre-recorded signal 202 may be a predetermined looping file that is a masked signal. Additionally, or alternatively, the pre-recorded signal 202 may be a vehicle chime, for example, a welcome sound, that plays at times during normal operation of the vehicle. In any event, the pre-recorded signal 202 is a predetermined sound that is designed to meet all the features required of the stimulus signal 122 for the ASP system 106 to operate effectively while remaining imperceptible to vehicle occupants.

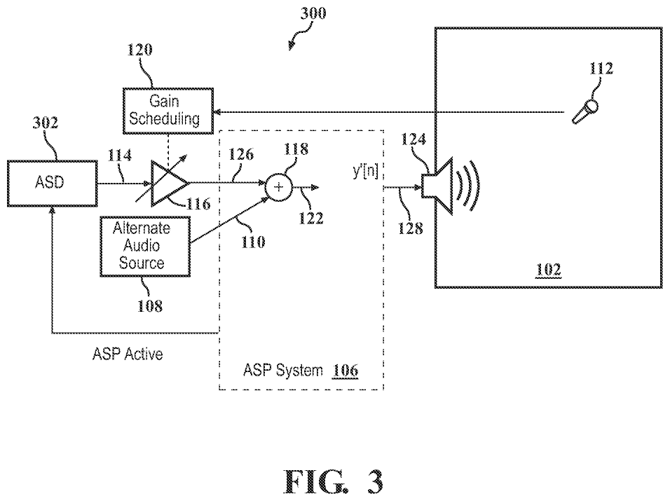

Referring to FIG. 3, one or more embodiments of the shaped noise generator 104 is shown in block diagram 300. The shaped noise signal 114 may be generated by an active sound design (ASD) system 302. ASD is a method of synthesizing combustion or electric vehicle powertrain sound. It may include one of several additive synthesis techniques and/or looping wave players. Because the ASD system 302 is an existing in-cabin sound generator, there are no added requirements or costs associated with using the ASD as the shaped noise generator for generating the shaped noise signal 114. ASD filter inputs from engine and vehicle speed, pedal inputs, exhaust noise, and vehicle vibrations to produce desired outputs. Because the sound generated by the ASD system 302 produces signals that are audio that already fits into the normal sounds of the vehicle cabin, the SNR of the shaped noise signal 114 produced by the ASD system 302 may advantageously have a higher SNR. The ASD output is designed to meet all the features required of the stimulus signal 122 for the ASP system 106 to operate effectively while remaining imperceptible to vehicle occupants.

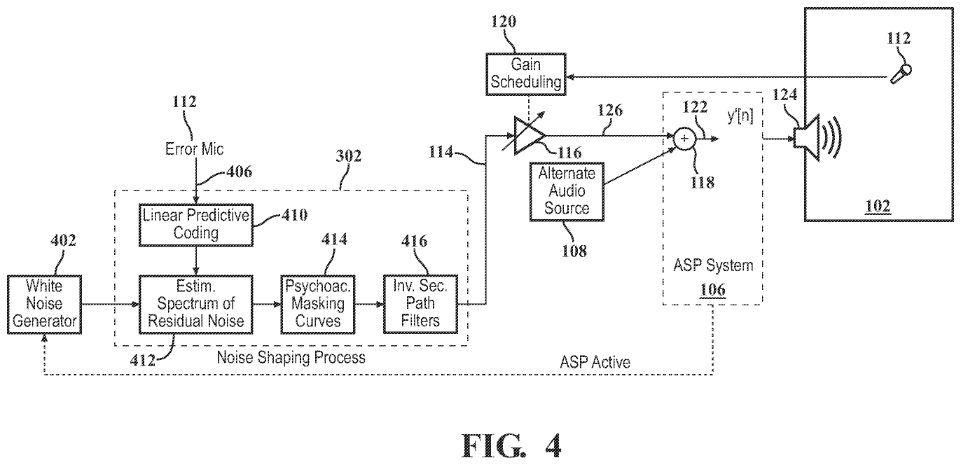

Referring to FIG. 4, one or more embodiments of the shaped noise generator 104 is shown in a block diagram 400. The system shown in FIG. 4 may work in conjunction with the ASD system of FIG. 3 to generate the shaped noise signal 114. The ASP system activates a white noise generator 402, which output signal 404 is fed to the ASD system 302. A residual noise signal 406, which is a current noise in the vehicle as measured by the error microphones 112 of the ANC system, is also fed to the ASD system 302. A linear predictive coding (LPC) component 410 of the ASD system 302 uses the residual noise signal 406, to fit a frequency domain response to the residual noise. Using a white noise generator output signal 404 and the output of the LPC component 410, the ASD system 302 estimates a spectrum of residual noise 412.

A psychoacoustic masking component 414 applies psychoacoustic masking curves to the estimated spectrum of residual noise 412 and the output passes through inverted secondary path filters 416 to generate the shaped noise signal 114.

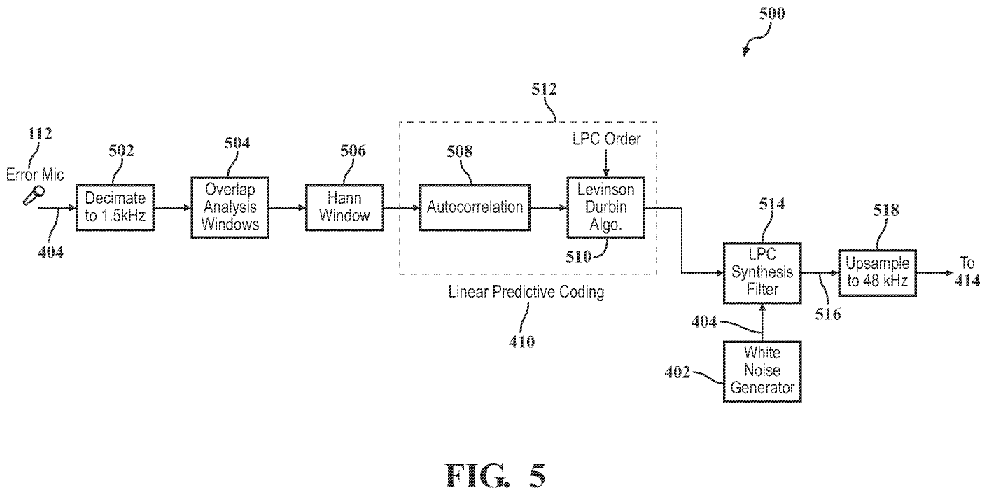

Referring to FIG. 5, a block diagram 500 for LPC 410 is shown in more detail. The residual noise signal 406 from the error microphone 112 is down sampled 502, or decimated, to a frequency of 1.5 kHz. An overlap analysis 504 is performed to eliminate duplicate data. Smoothing 506 is performed, as by a Hann Window. Autocorrelation 508 is performed and Levinson-Durbin algorithm 510 is applied with a predetermined LPC order 512. The processed signal is synthesized 514 with the output 404 of the white noise generator 402 and the synthesized signal 516 is upsampled 518 to 48 KHz.

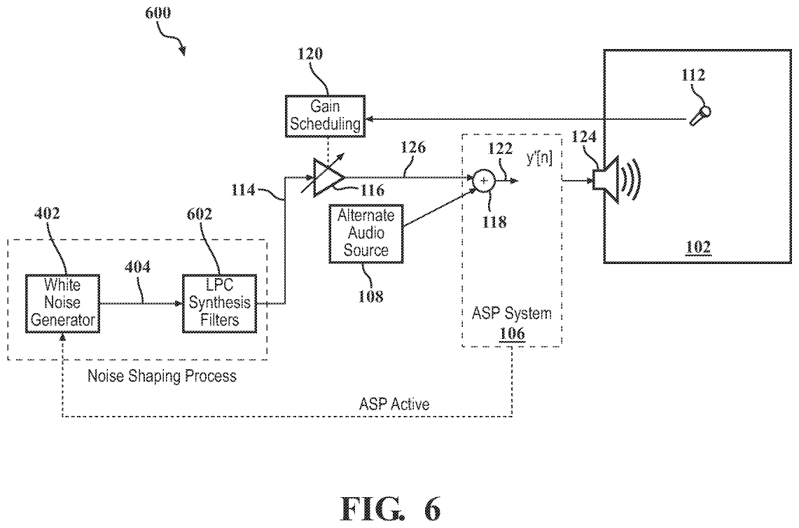

The one or more embodiments described with reference to FIG. 5 provides online updates for the LPC synthesis filters. In one or more embodiments, as shown in FIG. 6, the shaped noise generator 104 is shown in a block diagram 600 where the LPC synthesis filters (described in FIG. 5) are tuned offline. In FIG. 6, LPC filters 602 are applied to the output 404 of the white noise generator 402. The LPC filters 602 are predetermined, stored in memory, and selected, as by the ASP system 106, based on inputs to the ASP 106 that are representative of vehicle characteristics such as engine RPM or vehicle speed.

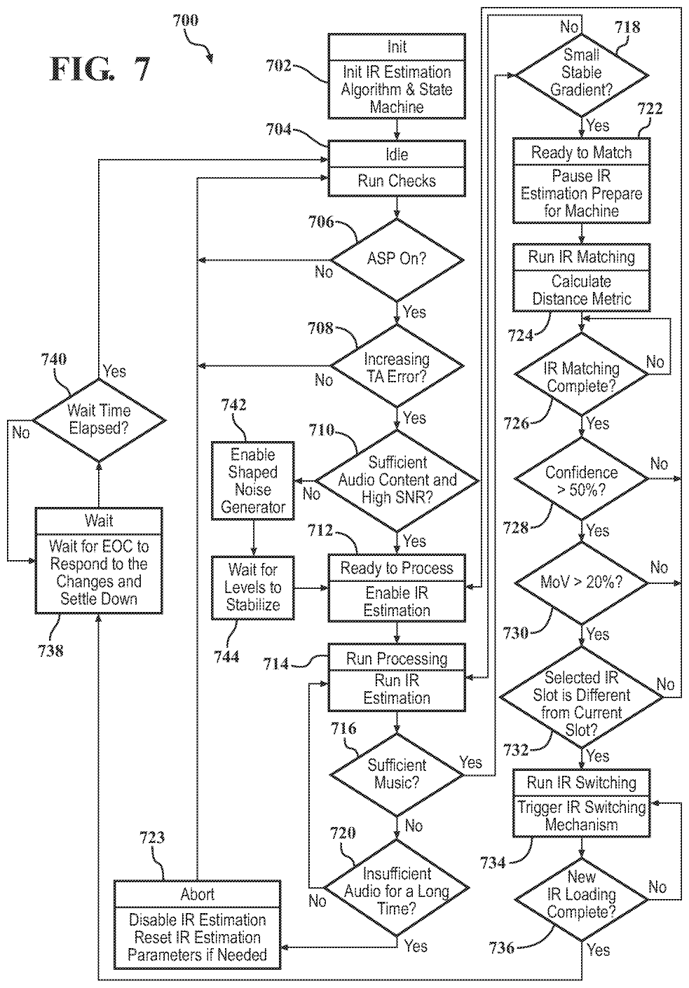

Referring to FIG. 7, a method 700 for performing secondary path switching using IR fingerprinting as described in U.S. Non-Provisional application Ser. No. 17/976,048, filed on Oct. 28, 2022, entitled “SYSTEM AND METHOD FOR SECONDARY PATH SWITCHING FOR ACTIVE NOISE CANCELLATION” are hereby incorporated by reference into the present disclosure, is shown. In step 702, the controller sets an algorithm for performing secondary path switching, IR fingerprinting, and matching conditions to initial conditions. In step 704, the controller remains idle and runs checks. For example, the controller may keep an estimate of the secondary acoustic transfer function Ŝₚᵤ(z) IR estimation algorithm (or secondary path IR re-estimation) inactive until predetermined conditions have been met. For example, in step 704, the controller may continuously monitor levels of various sets of signals as will be discussed in more detail below to determine when to enable or active the secondary path IR re-estimation algorithm. In addition to monitoring levels of various sets of signals, the controller may also determine whether there is sufficient spectral content and signal to noise (SNR) in the audio signals. Once these conditions have been met, the method 700 proceed to 712. In an embodiment, one or more of these quality checks can be omitted. In an embodiment, a different quality check, such as confidence score may be obtained as set forth in step 728, can alleviate the need for one or more conditions or quality checks. Step 728 will be described in more detail below.

In step 706, the controller determines whether an Adaptive Secondary Path (ASP) is initialized. The ASP corresponds to a process for performing an online secondary path estimate in a multiple input/multiple output (MIMO) environment. If the ASP process can identify a closer match to the secondary path, this aspect may improve cancellation performance and that secondary path will be utilized.

If this condition is true, then the method 700 moves to step 708. If not, then the method 700 moves back to step 704. In step 708, the controller determines whether an increasing True Audio (TA) error has occurred. The TA error corresponds to a difference between the audio signal predicted to be at the error microphone and the actual audio signal at the error microphone 112. If this difference is increasing, the TA error indicates that the model of the secondary path is inaccurate.

If this condition is true, then the method 700 moves to step 710. If not, then the method 700 moves back to step 704.

In step 710, the controller determines whether there is sufficient audio content present and whether the SNR for the audio signal is above a predetermined level. For the characterization of Ŝₚᵤ(z) to be non-invasive, it is desired that the levels of any test signals be as low such that the test signals are as inaudible to passengers as possible. However, the level of the test signals needs to be high enough such that the test signals can be detected at the error microphones. This aspect provides a range of optimal amplitudes of the test signals. If this condition is true, then the method 700 moves to step 712. If not, then the method 700 moves to step 742, as poor signal to noise ratio has rendered the test signals too noisy to be used to reliably estimate Ŝₚᵤ(z).

In step 742, the controller activates the shaped noise generator to generate a gain shaped noise signal that, when combined with the audio signals, has sufficient spectral content and signal to noise (SNR) in the audio signals. At step 744, the controller executes a WAIT state during which time the controller waits for levels to stabilize, which is indicated when the shaped noise generator generates an output. Once the levels have stabilized, the controller moves to step 712.

In step 712, the controller prepares for processing. In other words, the controller activates the secondary path IR re-estimation algorithm. In step 714, the controller works toward identifying the present audio configuration in the vehicle (or cabin in the vehicle). The controller continues to determine whether the audio content is sufficient in terms of spectral density and SNR in step 716. In general, the adaptive filter may only be adapted when the audio content is sufficiently flat over the required bandwidth. To accomplish this aspect, the method 700 may use spectral descriptors such as spectral flatness to determine if the audio content will allow proper convergence of the adaptive filters.

With respect to SNR levels of the error microphones in the vehicle, if background noise in the vehicle is much higher than the audio playing in the car, such noises may dominate estimation for the adaptive filter (or the secondary path estimation Ŝₚᵤ(z)) Thus, with this scenario, if audio is below the background noise of the vehicle, such a condition may indicate that secondary path estimation Ŝₚᵤ(z) is unreliable. In addition, with respect to the error levels on the microphones, the overall levels in the microphone (e.g., ANC microphones) may also be used to determine whether the estimated secondary path Ŝₚᵤ(z) is reliable. For example, if the microphone exhibits a consistently low amplitude, such a condition may indicate that the estimated secondary path Ŝₚᵤ(z) is not yet reliable. If the controller determines that the audio content is sufficient in terms of spectral density and SNR, the method 700 moves to step 718. If not, then the method 700 moves to step 720.

In step 720, the controller determines whether there is an insufficient amount of audio being received that exceeds a predetermined amount of time. If this condition is true, then the method 700 moves to step 724 and aborts. If not, the method 700 moves back to step 714. Also in step 714, the controller monitors one or more signals from the secondary path IR re-estimation algorithm to determine whether convergence has been achieved. In general, the error microphone provides an output which indicates that Ŝₚᵤ(z) has converged to an acceptable error to S(z). Additionally, or alternatively, signals derived from this error such as a gradient value from an adaptive filter using a gradient descent method may perform an online estimate of Ŝₚᵤ(z).

In step 718, the controller determines whether the audio content is exhibiting a small stable gradient. For example, the controller may compare a gradient on the audio content to a predetermined gradient value. A high gradient in the system may indicate that the filters for the estimated secondary path (e.g., Ŝₚᵤ(z)) have not converged on the IRs on the actual secondary path S(z). Since the gradient is usually a vector quantity, an L2 norm may be used to determine a convergence of the estimated secondary path, (e.g., Ŝₚᵤ(z)) filters (or convergence of the adaptive filters). When the L2 norm is consistently low (or below the predetermined gradient value), this may be indicative of the estimated secondary path, Ŝₚᵤ(z) being reliable. Thus, if this condition is true (e.g., gradient of the audio content is less than the predetermined gradient value), then the method 700 moves to step 722. If not (e.g., gradient of the audio content is greater than the predetermined gradient value), then the method 700 moves back to step 714.

In general, it may be desirable to ensure that the secondary path estimation Ŝₚᵤ(z) is reliable and can be used to update the secondary acoustic transfer function, S(z) with the secondary path estimation Ŝₚᵤ(z) such that the adaptation unit can use the secondary path estimation Ŝₚᵤ(z) to calculate the filter coefficients of the transfer function, W (z) for the adaptive filter 108. In general, while the system may reliably generate Ŝₚᵤ(z), this may not entail that the secondary path estimation of Ŝₚᵤ(z) results in robust or reliable fingerprints. The ANC system is configured for a default Ŝₚᵤ(z) when the ANC system starts up or may utilize the last determined Ŝₚᵤ(z) during the last step of the vehicle. The possible candidates for Ŝₚᵤ(z) are determined based on selection that may minimize performance degradation in the maximum number of likely cabin configurations. The controller also includes instructions for executing an adaptive filter (or deep learning, or system identification algorithm) that iteratively solves for the secondary path based on the reference component of the signal output from microphone and the receipt of that signal through the actual S(z) by all error microphones.

There may be several reasons as to why the Ŝₚᵤ(z) may not be reliable. For example, if the estimated secondary path estimation Ŝₚᵤ(z) was obtained by the adaptive filter of the controller, the adaptive filter may have misadjusted due to a variety of reasons or include coefficients whose values approach infinity (or provides a divergent filter). Conversely, if the secondary path estimation Ŝₚᵤ(z) was obtained by deep learning or system identification, then the estimate may not be accurate if the system was not trained and tested with as many real-world acoustic combinations as possible. Therefore, it is generally desirable to assess the reliability of Ŝₚᵤ(z) coefficients before such coefficients may be used for fingerprinting and updating the coefficients of Ŝₚᵤ(z).

A high error in ANC system may indicate that the filter for the estimated secondary path, Ŝₚᵤ(z) are diverging from the actual IRs for the secondary path S(z). A large error may indicate that convergence has not occurred thus causing Ŝₚᵤ(z) to be unreliable. Therefore, to implement this, the state machine (or the method 700) may compare the current error to a tunable threshold and if the error is below the threshold, then the method 700 may conclude that, for this metric, the Ŝₚᵤ(z) is reliable. In general, the controller monitors the error output by the microphone.

Generally, since the secondary path estimation Ŝₚᵤ(z) may be estimated using one or more of these methods, the exact process for validating the secondary path estimation Ŝₚᵤ(z) may vary. The method 700 provides an approach that uses many possible processes that are useful for validating the secondary path estimation Ŝₚᵤ(z) based on adaptive system identification. Any combination of these techniques below could be used. An example of this can be seen in the method 700 between steps 704 (e.g., IDLE) and 714 (e.g., Run IR Estimation) also including steps 706, 708, 710, 716, 718, and 720.

In step 722, the controller disables or deactivates the secondary path IR re-estimation algorithm and initializes IR fingerprinting and matching process.

In step 724, the controller activates or triggers a matching algorithm to perform IR fingerprinting. The fingerprints of one or more IRs are derived in this step. In general, the method 700 and the ANC system provides, for example, fingerprinting IRs to dynamically switch secondary path parameters in an online single input, single output (SISO) or MIMO ANC system. Fingerprinting involves, among other things, applying signal processing techniques to extract a unique signature from at least one, or every estimated impulse response Ŝₚᵤ(z) in the ANC system. Every IR in a multi-channel ANC system displays unique attributes about an electroacoustic path. These attributes account for signal processing components such as analog to digital (A/D) and digital to analog (D/A) converters, amplifiers, loudspeakers, microphones, and the acoustic path itself. The response of the electroacoustic path (i.e., the frequency response of the electroacoustic path), is affected to a greater degree by the acoustic properties of the vehicle cabin. For a typical vehicle cabin, the frequency response shows peaks and dips at various frequencies. In addition, the peaks and dips can shift in amplitude and frequency depending on a variety of factors such as temperature, seating configuration, number of vehicle occupants and so on. It is these variations in the frequency response that enable the opportunity to extract unique fingerprints from the IRs.

The pre-measured bank of IRs from the various configurations of the vehicle's cabin can be obtained either from a production vehicle IR measurement or from a different secondary path estimation, Ŝₚᵤ(z) estimation technique. Another approach may involve using the secondary path estimation Ŝₚᵤ(z) estimation algorithm itself to derive the pre-measured bank of IRs from the various acoustic cabin configuration. In addition, the controller may assign each cabin acoustic configuration in this bank to a tag (bank1, bank2, etc.) or using a lookup table (LUT). The pre-measured bank of IRs may be stored in memory (or the LUT 320) the associated with the controller as pre-stored IRs for comparison to one or more of the estimated impulse responses Ŝₚᵤ(z).

IRs measured in a production vehicle can yield more accurate fingerprints for multiple cabin configurations, because it uses a test signal to excite all frequencies. Another approach would be to use the Ŝₚᵤ(z) IR estimation algorithm itself to derive the IRs from the various acoustic combinations. Finally, each cabin acoustic configuration in this bank is assigned a tag (bank1, bank2, and so on.).

Once all the fingerprint characteristics have been extracted from the estimated Ŝₚᵤ(z) IR, the ANC system and method 700 may match the estimated secondary path Ŝₚᵤ(z) with an existing database of fingerprints (or predetermined (or pre-stored) secondary path estimations) from various cabin configurations is applied to find the closest match. Finally, the IR coefficients from the closest matching configuration are loaded by the adaptation unit into the adaptive filter of the ANC system. The ANC system performs the above method of estimating the impulse response and determining if there is a match to a prestored impulse response for every loudspeaker and microphone pair in the vehicle.

The matching process as executed by ANC system may involve the controller calculating a distance metric, ascertaining a winner (e.g., the closest matched IR value to the pre-stored IR), a confidence level of the match between the closest matched IR value in the estimated secondary path Ŝₚᵤ(z) to various pre-stored IR values, and determining a margin of victory (MOV) between the closest matched IR value to a plurality of the pre-stored IRs.

In step 724, the controller calculates the distance metric to determines the closest match between the secondary path estimate IR, Ŝₚᵤ(z), and the bank of previously stored IRs. Examples of distance metrics may include Euclidean norm, Lp norms or their variations such as, for example, the Hausdorff distance and normalized misalignment.

In step 726, the controller determines whether the matching is complete. For example, the controller establishes a voting matrix of the closest matched IR value relative to the closest previously stored IRs as stored in memory. If this condition is true (e.g., the voting matrix has been established), then the method 700 moves to step 728. If not, then the method 700 moves back to step 724.

In step 728, the controller establishes a confidence metric to determine a final winning IR configuration by considering aspects of the voting matrix. This will also be discussed in more detail in connection with FIG. 6. The controller determines whether the IR candidate exhibits a confidence level of that is greater than a predetermined value (e.g., 50%). If this condition is met, then the method 700 moves to step 732. If not, then the method 700 moves back to step 712.

In step 730, the controller determines a margin of victory (MOV) between the IR value for the secondary path estimate Ŝₚᵤ(z) and the closest IR value in the bank and the second closest IR value in the bank. The controller determines whether the MOV is above a predetermined MOV threshold (e.g., 20%). If the MOV is above the predetermined MOV threshold, then the method 700 moves to step 732. If not, then the method 700 moves back to step 712.

In step 732, the controller determines if the selected IR slot is different from the current slot. If the selected IR slot is identical to the current IR slot, then the best-fit IR is currently in use by the ANC system, and there is no need to change to a different IR. If this condition is true, then the method 700 moves to step 734 to perform the IR switching. If not, then the method 700 moves back to step 712. In step 734, the controller executes or performs IR switching. For example, the controller executes a trigger IR switching mechanism. In this case, the controller executes the IR switching mechanism to start transitioning from the old Ŝₚ(z) parameters with the new parameters that matched the Ŝₚᵤ(z) measurement. An abrupt switch may momentarily degrade ANC performance but is also possible. To avoid this condition, the IR switching mechanism includes a smooth slewing approach to minimize any audible artifacts. A time constant for slewing may be tunable or variable but could be in the range of, for example, 100 ms to several seconds to complete. Another embodiment may include instantaneously updating the IR for the secondary estimation path with the Ŝₚᵤ(z) coefficients for the adaptive filter. It is generally recognized that one aspect may involve utilizing the new parameters that matched the that matched the Ŝₚᵤ(z) measurement, not the parameters that that correspond to the impulse response measurement (or Ŝₚᵤ(z) measurement).

In general, the controller may perform one of the following options when executing the IR switching mechanism. In a first option, the controller updates all coefficients of the adaptive filter via the adaptation unit. For example, the LMS parameters of step size and leakage may be temporarily modified so that when the unintended transient occurs, the adaptive filters of the ANC system may not respond. In a second option, the controller performs a slewed (average) update of all the coefficients of the adaptive filter via the adaptation unit over a short period of time. In this case, the coefficients are gradually updated using, for example, an averaging filter to blend coefficients from the current value of the secondary path estimation Ŝₚᵤ(z) to new targeted coefficient values for the secondary path estimation Ŝₚᵤ(z). Averaging may either be linear or exponential and the total update time may be tunable (e.g., total update time range may be 40 ms to 5 seconds).

In step 736, the controller determines whether coefficients provided by the adaptation unit to the adaptive filter have been loaded properly. For example, the controller monitors the state of the ANC after the switch has occurred in step 734. If the proper coefficients have been property loaded, then the method 700 moves to step 738. If not, then the method 700 moves back to step 434.

In step 738, the controller executes a WAIT state. For example, the controller determines whether the selected IR (or new IR) is stable. In general, after the update is complete, the controller monitors the effects of the newly updated parameters. If the controller detects divergence or the error signals with these new IRs from the newly measured Ŝₚᵤ(z) seem excessively high or are higher than with the previous Ŝₚᵤ(z) from immediately prior to the coefficient swap, the controller could quickly revert to the previous parameters as such parameters are stored and not deleted. But if no issues are detected, then the controller may keep the estimated coefficients for the adaptive filter based on the estimated Ŝₚᵤ(z) frozen for a longer period (ex. 5-30 minutes) before resuming the IR estimation algorithm and repeating the same logic described above for deciding if, when, and how to update Ŝₚᵤ(z) again. This process may keep running for the entire duration of a vehicle ignition cycle. If the selected IR (or estimated secondary path Ŝₚᵤ(z)) is stable, then the method 700 moves to step 740. If not, then the method 700 moves back to step 734. In step 740, the controller determines if a timer for the WAIT state has expired. The controller employs the timer and waits for the timer to expire to determine if the state of the selected IR (or new IR) is stable. If the state of the selected IR is stable after the time expires, the method 700 moves to step 704. If not, then the method 700 moves back to step 738.

In general, aspects disclosed herein provide for a distance measurement (or misalignment) which is defined by an L2 Normalized Square Error between an estimated IR, Ŝₚᵤ(z) and an actual IR, Sₚ(z). This may be defined mathematically by the following equation:

Norm (Sₚ(z)−Ŝₚᵤ(z))/Norm (Sₚ(z)), which may then be converted to a logarithmic scale. It is recognized that the disclosed system may also perform the above equation in a time domain. This is generally referred to as a relative modeling error. One example of this relative modeling error is generally set forth in “A New Online Secondary Path Modeling Method with An Auxiliary Noise Power Scheduling Strategy for Narrowband Active Noise Control Systems”, Sun et al., 29 Nov. 2017 which is hereby incorporated by reference in its entirety. The controller provides a vector of distances between the various IRs, Ŝₚᵤ(z) and the stored IRs in a distance matrix.

1. A system for generating a stimulus signal for an adaptive secondary path of an active noise cancellation (ANC) system in a vehicle, the system comprising:
at least one audio signal source to provide an audio signal in a cabin of the vehicle;
a shaped noise generator to provide a shaped noise signal in the cabin of the vehicle;
at least one controller programmed to activate the shaped noise generator and add the shaped noise signal to the audio signal to generate a stimulus signal; and
at least one loudspeaker to project the stimulus signal within the cabin of the vehicle for the ANC system to generate an anti-noise signal.

2. The system as claimed in claim 1, further comprising:
at least one microphone to provide a signal indicative of a noise level in the cabin of the vehicle; and
a gain scheduling component to adjust a gain of the shaped noise signal to psychoacoustically mask the shaped noise signal and to maintain a constant signal to noise ratio (SNR), wherein the gain adjusted shaped noise signal is added to the audio signal to generate the stimulus signal.

3. The system as claimed in claim 1, wherein the shaped noise generator further comprises a pre-recorded signal.

4. The system as claimed in claim 3, wherein the pre-recorded signal is a looping masked signal.

5. The system as claimed in claim 3, wherein the pre-recorded signal is a chime of the vehicle.

6. The system as claimed in claim 1, wherein the shaped noise generator further comprises an active sound design (ASD) system.

7. The system as claimed in claim 6, wherein the shaped noise generator works along with the ASD and further comprises:
a white noise generator; and
a linear predictive coding component.

8. The system as claimed in claim 1, wherein the linear predictive coding component further comprises:
a white noise generator; and
a linear predictive coding component.

9. The system as claimed in claim 8, wherein the linear predictive coding component further comprises a set of predetermined LPC synthesis filters applied to an output of the white noise generator to generate the stimulus signal.

10. The system as claimed in claim 9, wherein the controller selects the predetermined LPC synthesis filters to apply to the output of the white noise generator based on vehicle parameters.

11. The system as claimed in claim 8, wherein the linear predictive coding component further comprises an input from an error microphone and the controller updating the LPC filters in real time based on the input from the error microphone.

12. The system as claimed in claim 11, further comprising:
at least one microphone to provide a signal indicative of a noise level in the cabin of the vehicle; and
a gain scheduling component to adjust a gain of the shaped noise signal, wherein the gain adjusted shaped noise signal is added to the audio signal to generate the stimulus signal.

13. A method for generating a stimulus signal for an adaptive secondary path of an active noise cancellation (ANC) system in a vehicle, the system comprising:
generating an audio signal in a cabin of the vehicle with at least one audio source;
generating a shaped noise signal in the cabin of the vehicle with a shaped noise generator, the shaped noise signal;
masking the shaped noise signal;
adding the masked shaped noise signal to the audio signal to generate a stimulus signal; and
projecting the stimulus signal within the cabin of the vehicle for the ANC system to generate an anti-noise signal.

14. The method as claimed in claim 13, further comprising the steps of:
detecting a noise level with a microphone in the vehicle cabin; and
adjusting a gain of the masked shaped noise signal to psychoacoustically mask the shaped noise signal and to maintain a constant signal to noise ratio (SNR).

15. The method as claimed in claim 13, further comprising the steps of activating the shaped noise generator to generate the shaped noise signal upon determining that the audio signal has insufficient content for the ANC system to generate an anti-noise signal.

16. The method as claimed in claim 13, wherein the step of masking the shaped noise signal further comprises:
generating a white noise signal; and
applying a set of linear predictive coding (LPC) filters to the white noise signal.

17. The method as claimed in claim 16, wherein the set of LPC filters is a predetermined set of LPC filters and the step of applying the set of LPC filters further comprises selecting, from the set of predetermined LPC filters, LPC filters to apply to the white noise signal wherein the LPC filter to apply are selected based on a vehicle speed or an engine revolutions per minute (RPM).

18. The method as claimed in claim 16, wherein the LPC filter in the set of LPC filters are tuned online based on an input from an error microphone and the method further comprises the step of updating the LPC filters in real time based on the input from the error microphone.

19. The method as claimed in claim 18 wherein the input from the error microphone is down sampled prior to applying the LPC filters and an output of the LPC filters is up sampled before being added to the audio signal.
